(19) United States
(12) Patent Application Publication
(10) Pub. No.: US 2017/0063831 A1
(43) Pub. Date: Mar. 2, 2017

(54) AUTHENTICATION OF A USER AND OF ACCESS TO THE USER'S INFORMATION

(71) Applicant: International Business Machines Corporation, Armonk, NY (US)

(72) Inventors: Robin Arnold, Hampshire (GB); Jeffrey D. Schaefer, Danbury, CT (US); Mahesh Viswanathan, Yorktown Heights, NY (US)

(21) Appl. No.: 14/833,261

(22) Filed: Aug. 24, 2015

(51) Int. Cl. H04L 29/06

(52) U.S. Cl. CPC H04L 63/083

(57) ABSTRACT

A method for authenticating a user having a username and password and authenticating access to the user's information. A client computer generates, and sends to a server computer, input data that includes a key (h1) to a dataset of salts accessible to the server computer, a proxy (h2) for the password, a proxy (h4) for the username, and in one embodiment, a different proxy (h8) for the username. The input data does not include the username in plaintext and does not include the password in plaintext. Using the input data and not utilizing the username in plaintext and not utilizing the password in plaintext, the server computer authenticates both the user and access to the user's information, after which the server computer sends, to the client computer, notification that the server computer has authenticated both the user and access to the user's information.

### TECHNICAL FIELD

The present invention is directed to authenticating a user and authenticating access to the user's information.

### BACKGROUND

Authentication systems are a key target for hackers, and millions of user credentials can be exposed when a system is compromised. Attackers may use vectors such as SQL-injection to obtain bulk access to credential data stores. Not all sites may use best practices governing the salting and hashing of passwords and weak hash implementations are particularly vulnerable to brute-force attacks. GPU/Hardware-accelerated attempts can perform billions of hashes per second.

Dictionary-assisted attacks have revealed up to 90% of the passwords in leaked credential data stores. Users frequently use the same username and password across multiple sites, increasing the probability of compromise. Username can be used as a key for targeted attacks (e.g., helping to identify high value individuals). Common credentials are vulnerable to the site with the weakest security. Password storage vulnerabilities are well known.

There is a need for improved authentication without the existing problems of the prior art.

### BRIEF SUMMARY

The present invention provides a method, and associated system and computer program product, for receiving notification that a user having a username and password has been authenticated and that access to the user's information has been authenticated. The method comprises:

receiving, by a client computer to which the user has access, the username, the password, and a constant salt s0;

said client computer computing t0 as a hash of: the username and the salt s0;

said client computer computing h0 as t0 modulo N, where N is at least 2;

said client computer determining a salt s1 from a site dataset of salts, wherein said determining the salt s1 comprises using h0 as a key pointing to a location, in the site dataset, at which the salt s1 is located;

said client computer computing h1 as a hash of: the username and the salt s1, wherein h1 is a key pointing to a location, in a first dataset of salts, at which a set of independent user salts is located, wherein the first dataset is stored at or accessible to a server computer;

said client computer sending a first request to the server computer for a plurality of salts comprising independent user salts s2 and s4 within the set of independent user salts pointed to by h1 in the first dataset, wherein the first request includes h1;

after said sending the first request, said client computer receiving, from the server computer, the plurality of salts including the salts s2 and s4;

said client computer computing a proxy (h2) for the password, wherein h2 is computed as a hash of: the password and the salt s2;

said client computer computing a proxy (h4) for the username, wherein h4 is computed as a hash of: the username and the salt s4;

said client computer sending a second request to the server computer for the server computer to authenticate both the user and access of the user's information, wherein the second request includes input data that comprises either first data or second data;

after the user and the access to the user's information have both been authenticated by the server computer using the input data sent by the client computer, said client computer receiving, from the server computer, notification that the server computer has authenticated both the user and access to the user's information,

wherein the second data comprises h1, h2, h4, and a proxy (h8) for the username and does not comprise the username in plaintext and does not comprise the password in plaintext and is sufficient for the server computer to authenticate the user and to authenticate access to the user's information without use of the username in plaintext and without use of the password in plaintext,

wherein the first data comprises h1, h2, and h4 and does not comprise h8 and does not comprise the username in plaintext and does not comprise the password in plaintext and is sufficient for the server computer to authenticate both the user and the access to the user's information without use of the username in plaintext and without use of the password in plaintext,

wherein h4 and h8 are independent of each other aside from both h4 and h8 depending on the username, and

wherein if the input data includes the second data then: (i) the requested plurality of salts further comprises independent user salt s7 within the set of independent user salts pointed to by h1 in the first dataset, wherein the salt s7 is independent of the salt s2 and the salt s4 and (ii) prior to said sending the second request, said client computer computing h8 as a hash of: the username and the salt s7.

The present invention provides a method, and associated system and computer program product, for authenticating a user having a username and password and authenticating access to the user's information. The method comprises:

said server computer authenticating both the user and access to the user's information, said authenticating both the user and access to the user's information utilizing the input data and not utilizing the username in plaintext and not utilizing the password in plaintext; and

after said authenticating both the user and access to the user's information, said server computer sending, to the client computer, notification that the server computer has authenticated both the user and access to the user's information,

wherein the first data comprises: (i) a proxy (h1) for the username, wherein h1 points to a location, in a first dataset of salts, at which a set of independent user salts is located, and wherein the first dataset is stored at or accessible to the server computer; (ii) a proxy (h2) for the password; and (iii) a proxy (h4) for the username, wherein the first data does not comprise the username in plaintext and does not comprise the password in plaintext,

wherein the second data comprises h1, h2, h4, and a proxy (h8) for the username, wherein the second data does not comprise the username in plaintext and does not comprise the password in plaintext;

wherein the first data does not comprise h8;

wherein each salt in the set of independent user salts is a unique function of the username and is specific to the server computer,

wherein h2 is a function of the password and is independent of the username and is specific to the server computer,

wherein h4 is a first function of the username and is independent of the password and is specific to the server computer,

wherein h8 is a second function of the username and is independent of the password and is specific to the server computer, and

wherein h4 and h8 are independent of each other aside from both h4 and h8 depending on the username.

### BRIEF DESCRIPTION OF THE DRAWINGS

FIG. 1 depicts a client-server system, in accordance with embodiments of the present invention.

FIG. 2 is a flow chart describing a method, performed by a client computer, for receiving notification that a user having a username and password has been authenticated and that access to the user's information has been authenticated, in accordance with embodiments of the present invention.

FIG. 3 is a flow chart describing a method, performed by a server computer, for authenticating a user having a username and password and authenticating access to the user's information, in accordance with embodiments of the present invention.

FIG. 4 is a flow chart of a process describing details of authenticating the user for a first embodiment of the method of FIG. 3.

FIG. 5 is a flow chart of a process describing details of authenticating access to the user's information for the first embodiment of the method of FIG. 3, in conjunction with authenticating the user according to FIG. 4.

FIG. 6 is a flow chart of a process describing details of authenticating the user for a second embodiment of the method of FIG. 3.

FIG. 7 is a flow chart of a process describing details of authenticating access to the user's information for the second embodiment of the method of FIG. 3, in conjunction with authenticating the user according to FIG. 6.

FIG. 8 illustrates a computer system used for implementing embodiments of the present invention.

### DETAILED DESCRIPTION

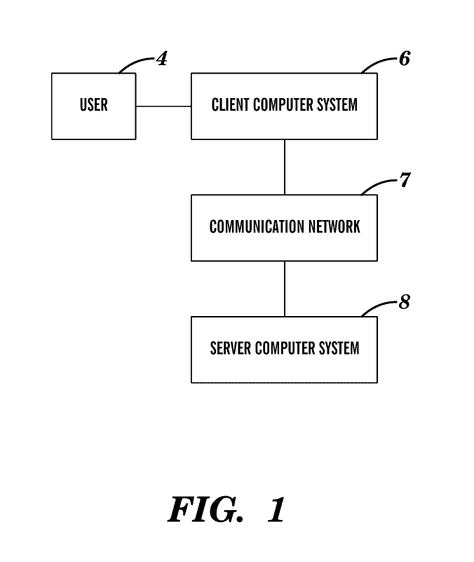

FIG. 1 depicts a client-server system, in accordance with embodiments of the present invention. In FIG. 1, a client computer system 6 communicates securely with a server computer system 8 via a communication network 7 which may be any known type of communication network such as, inter alia, the Internet, an Intranet, a local area network (LAN), a wide area network (WAN), etc.

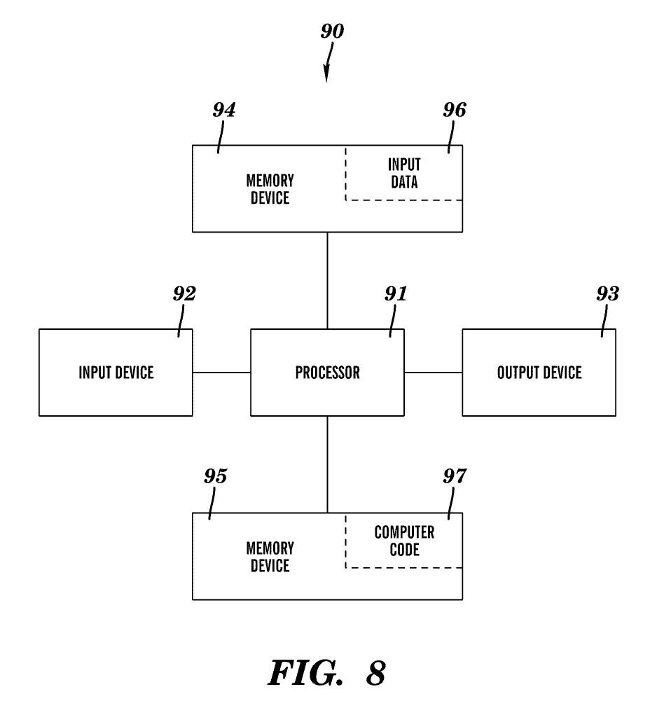

The client computer system 6 and the server computer system 8 may each independently be any known type of hardware computer system, such as, inter alia, the computer system 90 described infra in conjunction with FIG. 8.

In the description infra of the present invention, “client computer” means a client computer within the client computer system 6, and “server computer” means a server computer within the server computer system 8.

A user 4 having a username and password has access to the client computer system 6.

Embodiments of the present invention are directed to the server computer within the server computer system 8 authenticating the user 4 and authenticating access to the user's information stored in a dataset (e.g., file, table, etc.) at the server computer system 8, in conjunction with the user's access of a client computer within the client computer system 6. The user's information comprises any information pertaining to the user 4 (e.g., name, address, telephone number, interests, etc.).

In accordance with embodiments of the present invention, the username in plaintext and the password in plaintext are not transmitted to the server computer system 8 and are not used by the server computer system 8 to authenticate the user and authenticate access to the user's information. Plaintext is defined as unencrypted text. Plaintext is human-readable text and is in contrast, for example, with ciphertext that results from encryption of plaintext. It is noted that the username in ciphertext and the password in ciphertext are likewise not transmitted to the server computer system 8 and are not used by the server computer system 8 to authenticate the user and authenticate access to the user's information.

Instead, in accordance with embodiments of the present invention, a proxy value for the username (from hashing of the username with a salt) and a proxy value for the password (from hashing the password with a salt) are transmitted to the server computer system 8 to enable the server computer system 8 to authenticate the user and to authenticate access to the user's information.

A salt is an input random number to a hashing function that hashes a combination of an input parameter and the salt. Once a salt is selected as a random number, the selected salt is stored and is thus known deterministically. The combination may be any known combination that a person of ordinary skill in the art would invoke by combining the input parameter with the salt to perform a hashing operation on the combination. For example in one embodiment, if the input parameter is h and the salt is s, then the combination may be a concatenation of h and s (i.e., hs) or a concatenation of s and h (i.e., sh). In another example, the salt is used as a seed for internal registers that generates a hash.

The preceding proxy values for the username and password are different for every server computer system, making correlation of data across server computer systems impossible. A different password salt is used for each user on each server computer system, so a unique, uncorrelated hash of the password is generated even if the same password is used across server computer systems.

The server system 8 employs salting and hashing of the proxy values for the username and password that the server system 8 receives from the client system 6 for authenticating the user 4 and for authenticating access to the user's information.

With a suitably complex password, the user 4 can assume that the plaintext password is secure, even if the server system 8 does not use best practices to store the user's credentials.
With a suitably complex username, the user 4 can be protected against brute force attacks on the password hash, even if the underlying credential store is revealed. Attackers would have to brute force all credentials, which is impractical when using computationally expensive hash algorithms, because an attacker does not know which salt should be used to generate the proxy value for the password without prior knowledge of the username.

In accordance with embodiments of the present invention, security is enhanced further by storing a compound hash of username and password, so only an identical {server computer system, username, password} tuple will likely generate the same compound hash key.

In accordance with embodiments of the present invention, the client system 6 hides the plaintext username from the server computer system 10, thus greatly improving the safety of the user's identity which solves the problem of brute force, targeted attacks by using a trap door function to obtain the initial salt. A second salt/hash is used to provide a key to link to the backend user account information stored in the server computer system 8. This key is generated from the proxy information provided to the server computer system by the client computer system 6, but is not stored/associated with the credential information. An attacker therefore cannot connect user information with credential data, which could otherwise be useful in targeting attacks against high value user identities.

Embodiments of the present invention provide the following protections against targeted attacks:
Usernames with sufficient entropy can be protected from exposure.
A salt is selected at the client system 6 using a modulo N of the username's hash, wherein N may represent the size of a salt table. In one embodiment, N is large enough to thwart dictionary and rainbow table attacks. Thus, modulo N is a trap door that makes it impossible to infer the plaintext value.
A hashed proxy of the username is used as a key to obtain additional random salts, which are used to compute the client password hash, as well as the server-side hashes used to store the credentials for authenticating the user and authenticating access to the user's information.
The server computer system 8 cannot derive a plaintext username from any value transmitted by the client computer system 6.
The username proxy is unique for each server computer system, so attackers have no common key and cannot join data exposed from multiple s server computer systems.
With no knowledge of the plaintext username, attackers must brute-force the entire collection.
Computationally expensive hashes used in embodiments of the present invention make large scale attacks impractical.

In embodiments of the present invention, cryptographic hash functions may be used with extremely low probability of collision. Similar algorithms are commonly relied upon to perform deduplication in storage sub-systems; any collision on username hash would be detected during user registration, generating an error that would suggest to the user that the selected username was already in use, which has an extremely low probability of occurrence. Such similar, commonly relied upon algorithms perform computationally expensive hashing to slow down brute-force attacks.

For adequate protection, high-entropy usernames and passwords may be employed with embodiments of the present invention, which may leverage speed and scale of client computer systems.

With embodiments of the present invention, server computer systems perform their own salting and hashing to ensure security.

In one embodiment, the present invention may utilize any known salt algorithm for random cryptographically secure salt generation, in accordance with any embodiment within the scope of the present invention.

In one embodiment, the present invention may utilize any known hash algorithm to perform the hashing, in accordance with any embodiment within the scope of the present invention.

In one embodiment, the hash algorithms are computationally intensive, so that it takes a relatively long time to compute a hash. For example, the scrypt hashing function, which is purposely both cpu- and memory-resource intensive, may be used. Other hashing algorithms that may be used comprise, inter alia, PBKDF2 and bcrypt.

In the following Figure descriptions, “client computer” denotes a client computer within the client computer system 6, “server computer” denotes a server computer within the server computer system 8, and “user” denotes the user 4.

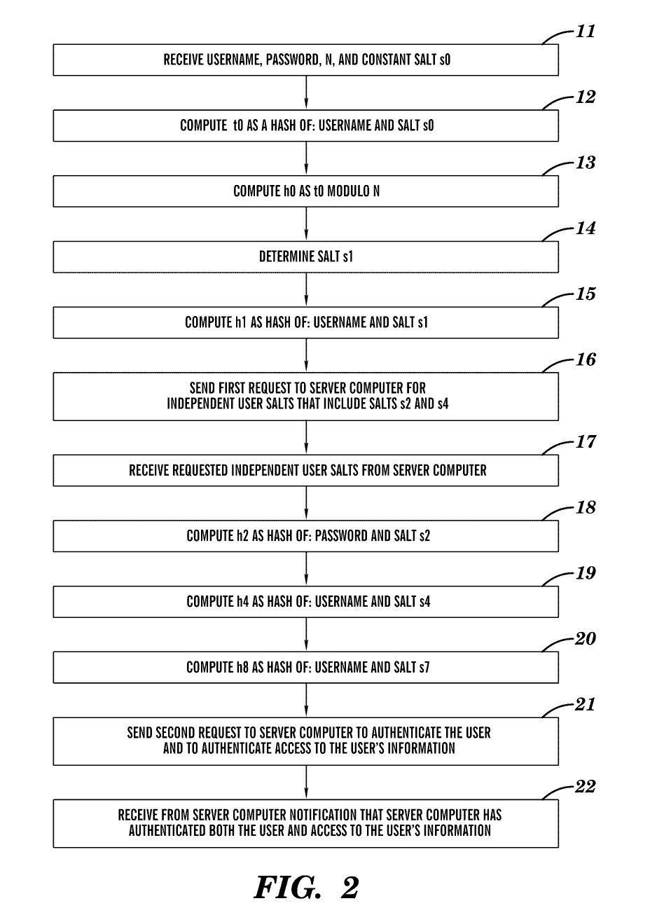

FIG. 2 is a flow chart describing a method, performed by the client computer, for receiving notification that the user having a username and password has been authenticated and that access to the user's information has been authenticated, in accordance with embodiments of the present invention. The flow chart of FIG. 2 includes steps 11-22.

In step 11, the client computer, to which the user has access, receives the username, the password, a positive integer N of at least 2, and a constant salt s0. The password and/or the username may be received from the user or from data storage accessible to the client computer. The salt s0 is assumed to be published and thus known. In one embodiment, the salt s0 is stored or cached at the client computer.

In step 12, the client computer computes t0 as a hash of: the username and the salt s0;

In step 13, the client computer computes h0 as t0 modulo N. For example, N may be 2, 3, 4, 5, 6, 7, 8, 9, 10, 11, 12, etc. As another example, N may be of the order of 10ⁿ where n is a positive integer of at least 1 (e.g., n=1, 2, 3, 4, 5, 6, 7, 8, 9, 10, 11, 12, etc.). N may be any number that is sufficiently large to thwart brute force attacks. In one embodiment, all bits of the generated hash for h0 are equally significant to permit compression to a relatively small number of distinct values. In one embodiment, the bit size for h0 is 4, but may be much larger than 4 in other embodiments.

In step 14, the client computer determines a salt s1 from site dataset of salts. The determination of the salt s1 comprises using h0 as a key pointing to a location in the site dataset at which the salt s1 is located. The site dataset may be publicly available and is either unique to the server computer or is independent of the server computer. The site dataset may be stored or cached at the client computer. The site dataset may be, inter alia, a list of salts or a table of salts such as the following illustrative table named “site_salts” in Table 1 for which N=8 and for which the key of h0=4 selects the salt s1 of “aGtf56Dg=”. N represents the size of the site dataset of salts.

TABLE 1
site_salts

| key | s1 |
|---|---|
| 0 | ab1234Cd= |
| 1 | Fc1X34Fe= |
| 2 | GtR6DKSf= |
| 3 | 0SF/dFR2= |
| 4 | aGtf56Dg= |
| 5 | ZAsd32kd= |
| 6 | 5G0HlzAd= |
| 7 | tyr8DxfZ= |

In step 15, the client computer computes h1 as a hash of: the username and the salt s1, wherein h1 is a key pointing to a location in a first dataset of salts at which a set of independent user salts (s2, s3, s4, s5, s6, s7, . . . ) is located for each value of the key h1. In one embodiment, the first dataset is stored at or accessible to the server computer. The first dataset may be, inter alia, a list of salts (e.g., a linked list) or a table of salts such as the following illustrative table named “user_salts” in Table 2.

Table 2
user_salts

| hl | s2 | s3 | s4 | s5 | s6 |
|---|---|---|---|---|---|
| aGtf56DgFcxSdfFd23= | Zblx35C1= | s30b/Q54Cx= | g61x34Fd= | P415JJCd= | y&DR34Xd= |

The preceding illustrative table “user salts” includes the set of salts s2, s3, s4, s5, and s6 for each key value of h1. Generally, each set of salts pointed to by a respective value of h1 in the first dataset may include as many salts as desired or needed for a particular use or for a variety of uses (e.g., the set of salts: s2, s3, . . . , s9).

The computed value of h1, which is unique for each user, is difficult to guess without knowing the username, and is uncorrelated between or among different server computer systems.

In one embodiment, the salt values s2, s3, s4, . . . in the first dataset are changed when the password is reset.

In step 16, the client computer sends a first request to the server computer for a plurality of salts selected from the set of salts pointed to by h1. The requested plurality of salts includes independent user salts s2 and s4 within the set of independent user salts pointed to by h1 in the first dataset. The first request includes h1.

The salts s2 and s4, along with h1 and the cleartext username and password, are treated as secrets and their risk of exposure are minimized, if not eliminated, in embodiments of the present invention. If h1 is compromised, security is weakened, but not lost as long as the username and password remain secure. If the username is compromised, security is weakened but not lost as long as the password remains secure. If the password is compromised, security is weakened but not lost as long as the username remains secure.

In step 17, after sending the first request, the client computer receives, from the server computer, the requested plurality of independent salts.

In step 18, the client computer computes a proxy (h2) for the password, wherein h2 is computed as a hash of: the password and the salt s2.

In step 19, the client computer computes a proxy (h4) for the username, wherein h1 is computed as a hash of: the username and the salt s4.

In step 20, the client computer computes a proxy (h8) for the username, wherein h8 is computed as a hash of: the username and a salt s7 from the first dataset. Step 20 may or may not be required to be performed as discussed infra in conjunction with alternative embodiments for authenticating the user having and for authenticating access to the user's information.

In step 21, the client computer sends a second request to the server computer for the server computer to authenticate the user and to authenticate access of the user's information. The second request includes input data that comprises either first data or second data, but not both. The first data and the second data are used in alternative embodiments for authenticating the user having and for authenticating access to the user's information.

In step 22, after the user and the access to the user's information have both been authenticated by the server computer using the input data sent by the client computer, the client computer receives, from the server computer, notification that the server computer has authenticated both the user and access to the user's information.

The first data comprises: h1, h2, and h4 and does not comprise h8. The first data does not comprise the username in plaintext and does not comprise the password in plaintext and is sufficient for the server computer to authenticate the user and to authenticate access to the user's information without use of the username in plaintext and without use of the password in plaintext.

The second data comprises h1, h2, h4, and h8. The second data does not comprise the username in plaintext and does not comprise the password in plaintext and is sufficient for the server computer to authenticate the user and to authenticate access to the user's information without use of the username in plaintext and without use of the password in plaintext.

The first data does not comprise h8 and the second data comprises h8.

If the input data includes the second data then: (i) the requested set of independent user salts further comprises independent user salt s7 which is independent of the salt s2 and the salt s4 and (ii) prior to said sending the second request, the client computer computes h8 (in step 20) as a hash of: the username and the salt s7. Thus, step 20 is required to be performed if the input data includes the second data. However, step 20 is not required to be performed if the input data includes the first data.

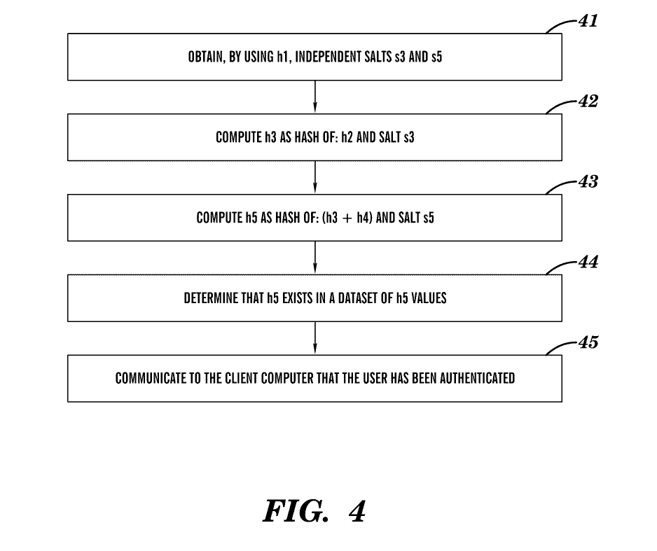

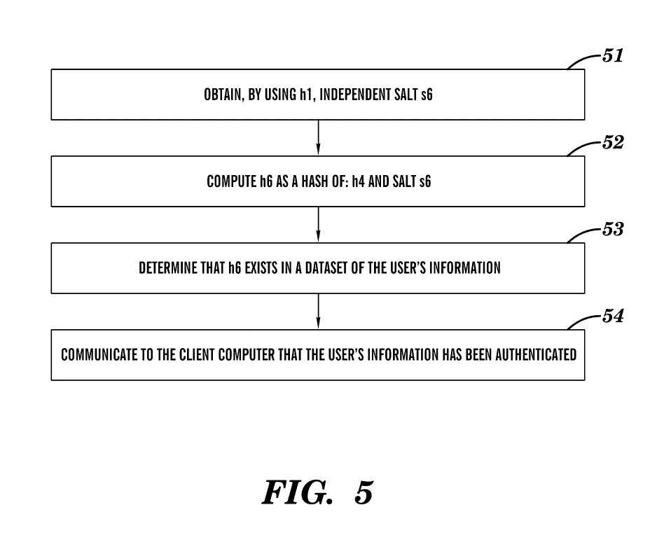

In one embodiment, the input data comprises the first data for use in a first embodiment of the present invention (FIGS. 4-5).

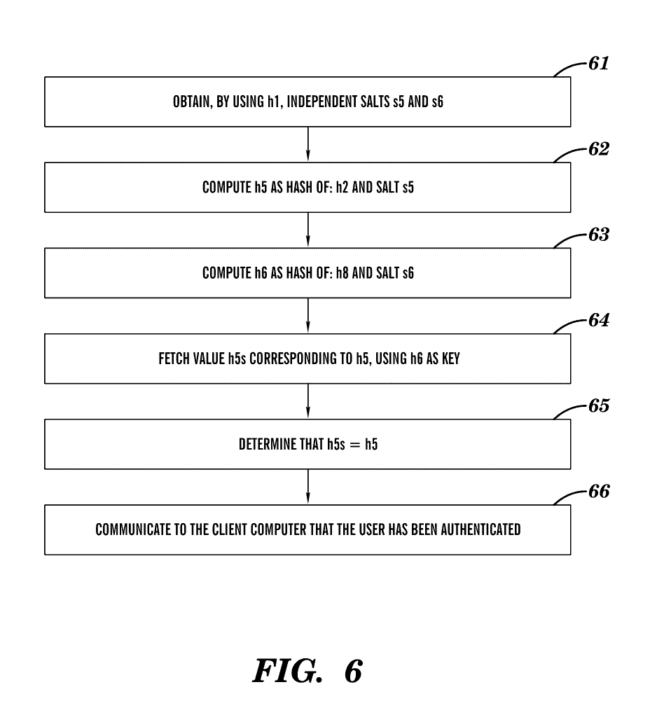

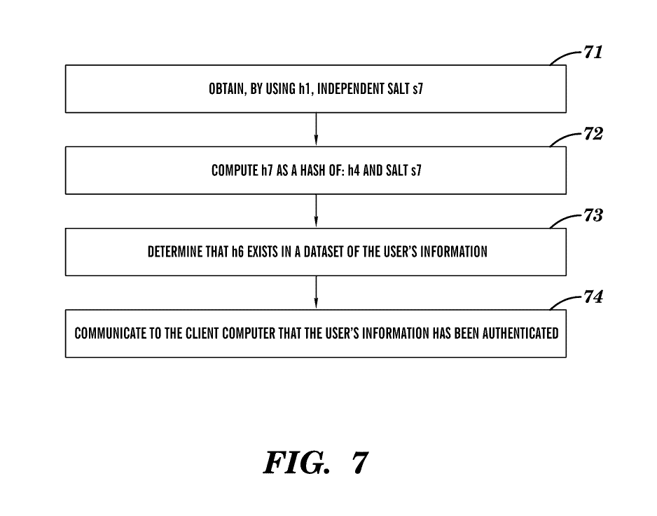

In one embodiment, the input data comprises the second data for use in a second embodiment of the present invention (FIGS. 6-7).

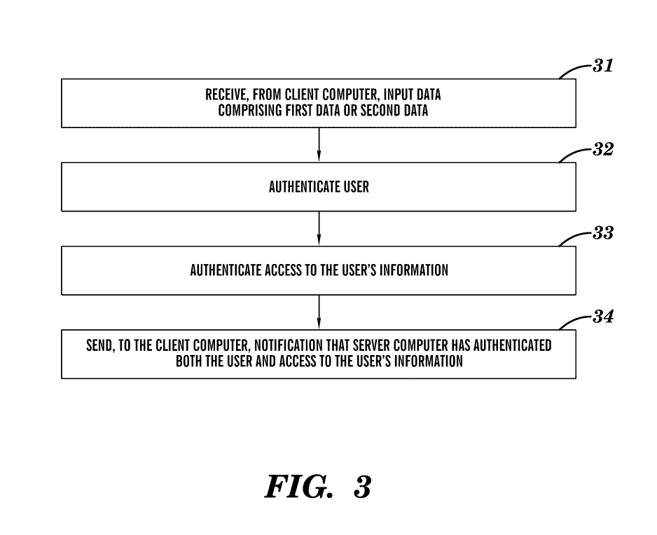

FIG. 3 is a flow chart describing a method, performed by the server computer, for authenticating the user having a username and password and authenticating access to the user's information, in accordance with embodiments of the present invention. The flow chart of FIG. 3 includes steps 31-34.

In step 31, the server computer receives, from a client computer to which the user has access, input data comprising either first data or second data, which is the first data or second data discussed supra in conjunction with steps 21-22 of FIG. 2.

In step 32, the server computer authenticates both the user and access to the user's information. Both authentications utilize the input data and do not utilize the username in plaintext and do not utilize the password in plaintext.

In step 33, the server computer authenticates access to the user's information utilizing the input data and not utilizing the username in plaintext and not utilizing the password in plaintext.

In step 34, after the server computer has authenticated the user according to step 32 and has authenticated access to the user's information according to step 33, the server computer sends, to the client computer, notification that the server computer has authenticated both the user and access to the user's information.

The first data comprises: (i) a pointer (h1) to a location in a first dataset of salts, at which a set of independent user salts is located, wherein the first dataset is stored at or accessible to the server computer; (ii) a proxy (h2) for the password; and (iii) a proxy (h4) for the username, as described supra in conjunction with FIG. 2. The first data does not comprise the username in plaintext and does not comprise the password in plaintext.

The second data comprises h1, h2, h4, and a proxy (h8) for the username, as described supra in conjunction with FIG. 2. The second data does not comprise the username in plaintext and does not comprise the password in plaintext.

The first data does not comprise h8.

Each salt in the set of independent user salts is a unique function of the username and is specific to the server computer.

The password proxy h2 is a function of the password and is independent of the username and is specific to the server computer.

The username proxy h4 is a first function of the username and is independent of the password and is specific to the server computer.

The username proxy h8 is a second function of the username and is independent of the password and is specific to the server computer.

The username proxy h4 and the username proxy h8 are independent of each other, aside from both h4 and h8 depending on the username.

FIGS. 4 and 5 implement an embodiment in which input data comprises the first data (h1, h2, and h4 but not h8).

FIG. 4 is a flow chart of a process describing details of authenticating the user for a first embodiment of step 32 in the method of FIG. 3 in which the input data is the first data. The flow chart of FIG. 4 includes steps 41-45.

In step 41, the server computer obtains, by using h1, independent salts s3 and s5 from the set of independent user salts pointed to by h1 in the first dataset.

In step 42, the server computer computes h3 as a hash of: h2 and the salt s3.

In step 43, the server computer computes h5 as a hash of: (h3+h4) and the salt s5. The term “(h3+h4)” is defined as a combination of h3 and h4 such as, inter alia, a concatenation of h3 and h4 (i.e., h3h4) or a concatenation of h4 and h3 (i.e., h4h3).

In step 44, the server computer determines that the computed h5 in step 43 exists in a second dataset of h5 values (denoted as h5s). The second dataset is at or accessible to the server computer. The second dataset may be, inter alia, a list or a table of h5 values (h5s) used for confirming the computed value of h5. An illustrative table representing the second dataset is named “user_auth1” and is depicted in Table 3.

TABLE 3
user_auth1
h5s
aZZ22D5FkdlZ09/=
. . .
. . .

In one embodiment, the salt values s2, s3, s4, . . . in the first dataset are changed when the password is reset, rendering the original compound hash h5s no longer reachable, even though the previous value of h5s may still remain in the second dataset in one embodiment. This has implications regarding the size of the second dataset; however, storage may be relatively cheap, and standard indexing and caching mechanisms ensure adequate performance for frequently used values of h5s. Leaving old h5s hashes in the second dataset makes bulk brute-force attacks even harder, because the probability of attacking a genuine h5 value is reduced, and because there is no way to determine which h5s values are reachable from the current set of salts in the first dataset.

In step 45 in response to the determination by the server computer in step 44 that h5 exists in the second database, the server computer communicates to the client computer that the user has been authenticated.

FIG. 5 is a flow chart of a process describing details of authenticating access to the user's information for the first embodiment of step 33 of the method of FIG. 3 in which the input data is the first data, in conjunction with authenticating the user according to FIG. 4. The flow chart of FIG. 5 includes steps 51-54.

In step 51, the server computer obtains, by using h1, salt s6 from the set of independent user salts in the first dataset pointed to by h1 in the first dataset, wherein the salt s6 is independent of the salt s3 and the salt s5.

In step 52, the server computer computes h6 as a hash of: h4 and the salt s6.

In step 53, the server computer determines that h6 exists in a third dataset of h6 values (denoted as h6s) derived from the username in a same manner that h6 was computed. The third dataset is at or accessible to the server computer. The user's information is stored in the third database and h6s is an index to the user's information in the third dataset. The third dataset may be, inter alia, a list or a table of h6 values (h6s) used for confirming the computed value of h6. An illustrative table representing the third dataset is named “user_details1” and is depicted in Table 4.

TABLE 4
user_details1

| h6s | user information |
|---|---|
| aGtf56DgFcxSdfFd23= | Zb1x35C1= |
| . . . | . . . |
| . . . | . . . |

In step 54 in response to the determination by the server computer in step 53 that h6 exists in the third dataset as a value of h6s, the server computer communicates to the client computer that access to the user's information has been authenticated.

The second dataset and the third dataset are generated in an initialization procedure prior to implementation of the processes of FIGS. 4 and 5, by: receiving the first data (h1, h2, and h4 but not h8) as input, computing h3 (as a hash of: h2 and the salt s3) and h5s (as a hash of: (h3+h4) and the salt s5) to generate the second dataset, and computing h6s (as a hash of: h4 and the salt s6) to generate the third dataset.

FIGS. 6 and 7 implement an embodiment in which input data comprises the second data (h1, h2, h4, and h8).

FIG. 6 is a flow chart of a process describing details of authenticating the user for a second embodiment of step 32 of the method of FIG. 3 in which the input data is the second data. The flow chart of FIG. 6 includes steps 61-66.

In step 61, the server computer obtains, by using h1, independent salts s5 and s6 from the set of independent user salts pointed to by h1 in the first dataset.

In step 62, the server computer computes h5 as a hash of: h2 and the salt s5.

In step 63, the server computer, computes h6 as a hash of: h8 and the salt s6.

In step 64, the server computer fetches, from a fourth dataset at or accessible to the server computer, a value h5s corresponding to h5 and derived from both the username and the password in a same manner that h5 was computed in step 62. Fetching h5s comprises using h6 as a key pointing to h5s in the fourth dataset. The fourth dataset is at or accessible to the server computer. The fourth dataset may be, inter alia, a list or a table of values of h6 and corresponding values of h5s used for confirming the computed value of h5. An illustrative table representing the fourth dataset is named “user_auth2” and is depicted in Table 5.

TABLE 5
user_auth2

| h6 | h5s |
|---|---|
| fG5F/Hu8AzswpsS3= | Zb1x35C1= |
| . . . | . . . |
| . . . | . . . |

In step 65, the server computer determines that h5s=h5.

In one embodiment, the salt values s2, s3, s4, . . . in the first dataset are changed when the password is reset, rendering the original compound hash h5s no longer reachable, even though the previous value of h5s may still remain in the fourth dataset in one embodiment. This has implications regarding the size of the second dataset; however, storage may be relatively cheap, and standard indexing and caching mechanisms ensure adequate performance for frequently used values of h5s. Leaving old h5s hashes in the fourth dataset makes bulk brute-force attacks even harder, because the probability of determining a genuine h5 value is reduced, and because there is no way to determine which h5s values are reachable from the current set of salts in the first dataset.

In step 66 in response to the determination by the server computer in step 65 that h5s=h5, the server computer communicates to the client computer that the user has been authenticated.

FIG. 7 is a flow chart of a process describing details of authenticating access to the user's information for the second embodiment of step 33 of the method of FIG. 3 in which the input data is the second data, in conjunction with authenticating the user according to FIG. 6. The flow chart of FIG. 7 includes steps 71-74.

In step 71, the server computer obtains, by using h1, salt s7 from the set of independent user salts pointed to by h1 in the first dataset, wherein the salt s7 is independent of the salt s5 and the salt s6.

In step 72, the server computer computes h7 as a hash of: h4 and the salt s7.

In step 73, the server computer determines that h7 exists in a fifth dataset of h7 values (denoted as h7s) derived from the username in a same manner that h7 was computed. The fifth dataset is at or accessible to the server computer. The user's information is stored in the fifth database and h7s is an index to the user's information in the fifth dataset. The fifth dataset may be, inter alia, a list or a table of values h7 (h7s) used for confirming the computed value of h7. An illustrative table representing the fifth dataset is named “user_details2” and is depicted in Table 6.

TABLE 6
user_details2

| h7s | user information |
|---|---|
| aGtf56DgFcxSdfFd23= | Zb1x35C1= |
| . . . | . . . |
| . . . | . . . |

In step 74 in response to the determination by the server computer in step 73 that h7 exists in the fifth dataset, the server computer communicates to the client computer that access to the user's information has been authenticated.

The fourth dataset and the fifth dataset are generated in an initialization procedure prior to implementation of the processes of FIGS. 6 and 7, by: receiving the second data (h1, h2, h4, and h8) as input, computing h5s (as a hash of: h2 and the salt s5) and h6 (as a hash of: h8 and the salt s6) to generate the fourth dataset, and computing h7s (as a hash of: h4 and the salt s7) to generate the fifth dataset.

An attribute of embodiments of the present invention is that neither the username nor the password is sent to the server computer, which puts control back in user's hands. If a user provides a username and password with sufficient entropy, the user can feel confident that the user's secrets cannot be revealed, regardless of any security lapses by the server computer with which the user is communicating. The hashing function running on the client computer may be open, to allow the users to develop trust for the hashing function. The implementation on the server computer can be proprietary.

The risk is therefore shifted entirely to each server computer system to protect the server computer system's assets. If a particular server computer experiences a breach, only the particular server computer is impacted. The client-side hashing of username and password using a suitable hashing algorithm guarantees that the breached data cannot be used to compromise the security of a user's credentials on another server computer, even if the same user and password high entropy combination values are used. This can be contrasted with traditional mechanisms where even a high entropy password is vulnerable to a breach of the server computer system with poor security, because both the username and password are entrusted to the server computer system.

Another attribute of embodiments of the present invention is that the user information details are separated from the authentication information. There are multiple datasets with keys that are uncorrelated unless one can discover the value of the username, which is never actually sent to the server computer system. In order to map user information details to a credential, the username must be known, which assumes that the hash function is sufficiently robust to ensure that the hash values using different salts but the same cleartext are not correlated in any way.

Credential data is not correlated between server computer systems except via the username. In one embodiment, each server computer system uses a unique salt s0 that influences the calculation for h0 and hence h1. Each server computer system has its own user first dataset salts with salt values computed using cryptographically safe random number generators, so that the probability of salt collision is tiny.

In one embodiment for increased or maximum security, the username should be used only for the purposes of authentication. It should be possible to change usernames as easily as passwords may be changed. If forgotten, a username can even be reset, which will leave orphaned records in the site dataset, the first dataset, the second dataset, and the fourth dataset. However, because the user information will be associated with a new credential entry, these orphaned records are just noise, and cannot be used to complete authentication in the future.

Suitable hash functions will restrict the number of guesses per second that can be performed, and the hash function is not easily accelerated by GPU or custom ASIC implementations.

The salts, authorization values (h5s), and user information details are separated. As an example, assume that an attacker is able to obtain the third or fifth dataset containing user information, and is able to view/decrypt information related to the name of the user. In traditional scenarios, this information could be used to single out high profile users (celebrities, politicians, etc.) and focus attempts to attack the credentials by brute force. With embodiments of the present invention, the key for the third or fifth dataset is not correlated with the key for the second or fourth dataset or with the first dataset of salts.

In the embodiment in which the input data is the second data, knowing the user information key h7 does not reveal the associated authorization key h6, so that an attacker does not know which password value in the fourth dataset. An attacker must attack all of the passwords in the fourth dataset, or attempt to guess the username in which case the attacker can compute h1 and correlate the records in the first, fourth, and fifth datasets. However, this is computationally hard if a username with sufficient entropy is used. If a username (such as a publically known email address) is used, then the correlation is trivial, and this benefit is lost. But the password still remains computationally difficult to guess if a suitable hash function is used. Protection increases as the number of entries increases because the keys for the datasets are not correlated. Only the username binds everything together.

Because disk is cheap, implementers can populate the salt dataset and the third and fifth datasets with randomly generated values, essentially hiding the real information in a large haystack, making it even more expensive for an attacker to find a wanted entry. Because all the keys are hash values and the user information may be encrypted, it becomes impossible to tell which records are the fake ones and which records are the real ones.

FIG. 8 illustrates a computer system 90 used for implementing methods of embodiments of the present invention. The computer system 90 comprises a processor 91, an input device 92 coupled to the processor 91, an output device 93 coupled to the processor 91, and memory devices 94 and 95 each coupled to the processor 91. The processor 90 denotes one or more processors. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory devices 94 and 95 each denote one or more memory devices. The memory device 95 includes a computer code 97 which is a computer program that comprises computer-executable instructions. The computer code 97 includes software or program instructions that may implement an algorithm for implementing methods of embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 8) may be used as a computer readable storage medium (or program storage device) having a computer readable program embodied therein and/or having other data stored therein, wherein the computer readable program comprises the computer code 97. Generally, a computer program product (or, alternatively, an article of manufacture) of the computer system 90 may comprise said computer readable storage medium (or said program storage device).

The client computer system 6 and the server computer system 8 in FIG. 1 may utilize a computer system such as computer system 90.

A computer of the computer system 90, which comprises the processor 91 and the memory devices 94 and 95, may represent the client computer of the client computer system 6 and/or the server computer of the server computer system 8.

Embodiments of the present invention disclose a process for supporting, deploying and/or integrating computer infrastructure, integrating, hosting, maintaining, and deploying computer-readable code into the computer system 90, wherein the code in combination with the computer system 90 is capable of performing methods of embodiments of the present invention.

In another embodiment, the invention provides a method that performs the process steps of embodiments of the invention on a subscription, advertising, and/or fee basis. In this case, the service provider can create, integrate, host, maintain, deploy, manage, service, support, etc., a computer infrastructure that performs the process steps of embodiments of the invention for one or more customers. In return, the service provider can receive payment from the customer(s) under a subscription and/or fee agreement and/or the service provider can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for receiving notification that a user having a username and password has been authenticated and that access to the user's information has been authenticated, said method comprising:
receiving, by a client computer to which the user has access, the username, the password, an integer N of at least 2, and a constant salt s0;
said client computer computing t0 as a hash of: the username and the salt s0;
said client computer computing h0 as t0 modulo N;
said client computer determining a salt s1 from a site dataset of salts, wherein said determining the salt s1 comprises using h0 as a key pointing to a location, in the site dataset, at which the salt s1 is located;
said client computer computing h1 as a hash of: the username and the salt s1, wherein h1 is a key pointing to a location, in a first dataset of salts, at which a set of independent user salts is located, wherein the first dataset is stored at or accessible to a server computer;
said client computer sending a first request to the server computer for a plurality of salts comprising independent user salts s2 and s4 within the set of independent user salts pointed to by h1 in the first dataset, wherein the first request includes h1;
after said sending the first request, said client computer receiving, from the server computer, the plurality of salts including the salts s2 and s4;
said client computer computing a proxy (h2) for the password, wherein h2 is computed as a hash of: the password and the salt s2;
said client computer computing a proxy (h4) for the username, wherein h4 is computed as a hash of: the username and the salt s4;
said client computer sending a second request to the server computer for the server computer to authenticate both the user and access of the user's information, wherein the second request includes input data that comprises either first data or second data;
after the user and the access to the user's information have both been authenticated by the server computer using the input data sent by the client computer, said client computer receiving, from the server computer, notification that the server computer has authenticated both the user and access to the user's information,
wherein the second data comprises h1, h2, h4, and a proxy (h8) for the username and does not comprise the username in plaintext and does not comprise the password in plaintext and is sufficient for the server computer to authenticate the user and to authenticate access to the user's information without use of the username in plaintext and without use of the password in plaintext,
wherein the first data comprises h1, h2, and h4 and does not comprise h8 and does not comprise the username in plaintext and does not comprise the password in plaintext and is sufficient for the server computer to authenticate both the user and the access to the user's information without use of the username in plaintext and without use of the password in plaintext,
wherein h4 and h8 are independent of each other aside from both h4 and h8 depending on the username, and
wherein if the input data includes the second data then: (i) the requested plurality of salts further comprises independent user salt s7 within the set of independent user salts pointed to by h1 in the first dataset, wherein the salt s7 is independent of the salt s2 and the salt s4 and (ii) prior to said sending the second request, said client computer computing h8 as a hash of: the username and the salt s7.

2. The method of claim 1, wherein the input data comprises the first data.

3. The method of claim 1, wherein the input data comprises the second data.

4. The method of claim 1, wherein the site dataset is stored or cached at the client computer.

5. A method for authenticating a user having a username and password and authenticating access to the user's information, said method comprising:
receiving, by a server computer from a client computer to which the user has access, input data comprising either first data or second data;
said server computer authenticating both the user and access to the user's information, said authenticating both the user and access to the user's information utilizing the input data and not utilizing the username in plaintext and not utilizing the password in plaintext; and
after said authenticating both the user and access to the user's information, said server computer sending, to the client computer, notification that the server computer has authenticated both the user and access to the user's information,
wherein the first data comprises: (i) a proxy (h1) for the username, wherein h1 points to a location, in a first dataset of salts, at which a set of independent user salts is located, and wherein the first dataset is stored at or accessible to the server computer; (ii) a proxy (h2) for the password; and (iii) a proxy (h4) for the username, wherein the first data does not comprise the username in plaintext and does not comprise the password in plaintext,
wherein the second data comprises h1, h2, h4, and a proxy (h8) for the username, wherein the second data does not comprise the username in plaintext and does not comprise the password in plaintext;
wherein the first data does not comprise h8;
wherein each salt in the set of independent user salts is a unique function of the username and is specific to the server computer,
wherein h2 is a function of the password and is independent of the username and is specific to the server computer,
wherein h4 is a first function of the username and is independent of the password and is specific to the server computer,
wherein h8 is a second function of the username and is independent of the password and is specific to the server computer, and
wherein h4 and h8 are independent of each other aside from both h4 and h8 depending on the username.

6. The method of claim 5, wherein the input data comprises the first data.

7. The method of claim 6, wherein said authenticating the user comprises:
obtaining, by using h1, independent salts s3 and s5 from the set of independent user salts;
computing h3 as a hash of: h2 and the salt s3;
computing h5 as a hash of: (h3+h4) and the salt s5;
determining that h5 exists in a second dataset of h5 values, wherein the second dataset is at or accessible to the server computer; and
in response to having determined that h5 exists in the second dataset, communicating to the client computer that the user has been authenticated.

8. The method of claim 7, wherein said authenticating access to the user's information comprises:
obtaining, by using h1, salt s6 from the row of independent user salts, wherein the salt s6 is independent of the salt s3 and the salt s5;
computing h6 as a hash of: h4 and the salt s6;
determining that h6 exists in a third dataset of h6 values, wherein the third dataset is at or accessible to the server computer, and wherein the user's information is stored in the third dataset; and
in response to having determined that h6 exists in the third dataset, communicating to the client computer that access to the user's information has been authenticated.

9. The method of claim 8, wherein h6 is an index to the user's information in the third dataset.

10. The method of claim 5, wherein the input data comprises the second data.

11. The method of claim 10, wherein said authenticating the user comprises:
obtaining, by using h1, independent salts s5 and s6 from the set of independent user salts;
computing h5 as a hash of: h2 and the salt s5;
computing h6 as a hash of: h8 and the salt s6;
fetching, from a fourth dataset at or accessible to the server computer, a value h5s corresponding to h5 and derived from both the username and the password, said fetching h5s comprising using h6 as a key pointing to h5s in the fourth dataset, wherein the fourth dataset is at or accessible to the server computer;
determining that h5s=h5; and
in response to having determined that h5s=h5, communicating to the client computer that the user has been authenticated_{[A1]}.

12. The method of claim 11, wherein said authenticating access to the user's information comprises:
obtaining, by using h1, salt s7 from the set of independent user salts, wherein the salt s7 is independent of the salt s5 and the salt s6;
computing h7 as a hash of: h4 and the salt s7;
determining that h7 exists in a fifth dataset of h7 values, wherein the fifth dataset is at or accessible to the server computer, and wherein the user's information is stored in the fifth dataset; and
in response to having determined that h7 exists in the fifth dataset, communicating to the client computer that access to the user's information has been authenticated_{[A2]}.

13. The method of claim 12, where h7 is an index to the user's information in the fifth dataset.

14. A computer program product, comprising one or more computer readable storage devices storing computer readable program code which, upon being executed by one or more processors of a server computer, implement a method for authenticating a user having a username and password and authenticating access to the user's information, said method comprising:
receiving, by the server computer from a client computer to which the user has access, input data comprising either first data or second data;
said server computer authenticating both the user and access to the user's information, said authenticating both the user and access to the user's information utilizing the input data and not utilizing the username in plaintext and not utilizing the password in plaintext; and
after said authenticating both the user and access to the user's information, said server computer sending, to the client computer, notification that the server computer has authenticated both the user and access to the user's information,
wherein the first data comprises: (i) a proxy (h1) for the username, wherein h1 points to a location, in a first dataset of salts, at which a set of independent user salts is located, and wherein the first dataset is stored at or accessible to the server computer; (ii) a proxy (h2) for the password; and (iii) a proxy (h4) for the username, wherein the first data does not comprise the username in plaintext and does not comprise the password in plaintext,
wherein the second data comprises h1, h2, h4, and a proxy (h8) for the username, wherein the second data does not comprise the username in plaintext and does not comprise the password in plaintext;
wherein the first data does not comprise h8;
wherein each salt in the set of independent user salts is a unique function of the username and is specific to the server computer,
wherein h2 is a function of the password and is independent of the username and is specific to the server computer,
wherein h4 is a first function of the username and is independent of the password and is specific to the server computer,
wherein h8 is a second function of the username and is independent of the password and is specific to the server computer, and
wherein h4 and h8 are independent of each other aside from both h4 and h8 depending on the username.

15. The computer program product of claim 14, wherein the input data comprises the first data.

16. The computer program product of claim 15, wherein said authenticating the user comprises:
obtaining, by using h1, independent salts s3 and s5 from the set of independent user salts;
computing h3 as a hash of: h2 and the salt s3;
computing h5 as a hash of: (h3+h4) and the salt s5;
determining that h5 exists in a second dataset of h5 values, wherein the second dataset is at or accessible to the server computer; and
in response to having determined that h5 exists in the second dataset, communicating to the client computer that the user has been authenticated_{[A3]}.

17. The computer program product of claim 15, wherein said authenticating access to the user's information comprises:
obtaining, by using h1, salt s6 from the row of independent user salts, wherein the salt s6 is independent of the salt s3 and the salt s5;
computing h6 as a hash of: h4 and the salt s6;
determining that h6 exists in a third dataset of h6 values, wherein the third dataset is at or accessible to the server computer, and wherein the user's information is stored in the third dataset; and
in response to having determined that h6 exists in the third dataset, communicating to the client computer that access to the user's information has been authenticated_{[A4]}.

18. The computer program product of claim 14, wherein the input data comprises the second data.

19. The computer program product of claim 18, wherein said authenticating the user comprises:
obtaining, by using h1, independent salts s5 and s6 from the set of independent user salts;
computing h5 as a hash of: h2 and the salt s5;
computing h6 as a hash of: h8 and the salt s6;
fetching, from a fourth dataset at or accessible to the server computer, a value h5s corresponding to h5 and derived from both the username and the password, said fetching h5s comprising using h6 as a key pointing to h5s in the fourth dataset, wherein the fourth dataset is at or accessible to the server computer,
determining that h5s=h5; and
in response to having determined that h5s=h5, communicating to the client computer that the user has been authenticated_{[A5]}.

20. The computer program product of claim 19, wherein said authenticating access to the user's information comprises:
obtaining, by using h1, salt s7 from the set of independent user salts, wherein the salt s7 is independent of the salt s5 and the salt s6;
computing h7 as a hash of: h4 and the salt s7;
determining that h7 exists in a fifth dataset of h7 values, wherein the fifth dataset is at or accessible to the server computer, and wherein the user's information is stored in the fifth dataset; and
in response to having determined that h7 exists in the fifth dataset_{[A6]}, communicating to the client computer that access to the user's information has been authenticated.
